(19) United States
(12) Patent Application Publication
(10) Pub. No.: US 2003/0156688 A1
(43) Pub. Date: Aug. 21, 2003

(54) Message recording and playback system

(76) Inventors: William A. McCarty, San Diego, CA (US); Johannes Brons, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/369,265

(22) Filed: Feb. 14, 2003

Related U.S. Application Data
(60) Provisional application No. 60/357,726, filed on Feb. 15, 2002.

(51) Int. Cl. H04M 1/64

(52) U.S. Cl. 379/67.1

(57) ABSTRACT

A system and method for recording and playing back messages is described having a microphone that converts sound into electrical message signals, a memory, a motion sensor that detects motion and develops a motion signal in response to the detected motion, a speaker; and a control module in communication with the other components, along with other components. The control module can accept message signals from the microphone and store them in the memory. Upon receiving a motion detected signal from the motion sensor, the control module can retrieve the message signals from the memory and transfer them to the speaker for playback. The control module can utilize a timing control that prevents motion signals from triggering a subsequent playback until a preset period of time has elapsed.

### RELATED APPLICATIONS

This application claims priority to U.S. Provisional Patent Application No. 60/357,726, filed Feb. 15, 2002.

### BACKGROUND OF THE INVENTION

1. Field of the Invention

The invention is related to the field of message recording and playback systems.

2. Description of the Related Art

Property sales systems exist that play messages to visitors who are viewing sale properties and these systems are utilized to provide information to the visitors as they travel through a property. Current devices playing audio messages generally utilize some form of sensor to activate a playback of prerecorded messages that are to be delivered when the sensor is activated. In general, these devices accept a prerecorded message and when the sensor is tripped, they will play the message through a speaker to an intended audience. Certain systems will utilize a progressive mode such that when successive sensors are tripped, successive messages will be played. Yet other systems will play one message on the first tripping of a sensor and play different messages on subsequent trips of the sensor.

Other systems utilizing similar technology simulate home occupancy when homeowners are away. These systems may utilize sensors in various parts of a home, where each sensor actuates some system response. For instance, one sensor may activate a noise playback that sounds like somebody walking through an adjacent room, while another sensor can simulate voices talking.

### SUMMARY OF THE INVENTION

The systems and methods have several features, no single one of which is solely responsible for its desirable attributes. Without limiting the scope as expressed by the claims that follow, its more prominent features will now be discussed briefly. After considering this discussion, and particularly after reading the section entitled “Detailed Description of the Preferred Embodiment” one will understand how the features of the system and methods provide several advantages over traditional systems and methods.

One aspect is a system for recording and playing back messages, having a microphone, a memory, a motion sensor that detects motion and develops a motion signal in response to the detected motion, a speaker, and a control module in communication with the other components. The control module can accept message signals from the microphone and store them in the memory. Upon receiving a motion detected signal from the motion sensor, the control module can retrieve the message signals from the memory and transfer them to the speaker for playback. The controller can utilize a timing control that prevents motion signals from triggering a subsequent playback until a preset period of time has elapsed.

In another aspect the message recording and playback system is controlled by an actuation module for manually actuating a playback of the message signals. In some aspects, the system is contained in a portable housing, while in other aspects any or all of the components may be located remotely with respect to one another. In some aspects, the system is controlled by voice commands or audible signals.

In yet another aspect, the system may be mounted in a portable housing or it may be mounted in switch or fixture housings in a house or other building. Certain aspects incorporate connections to peripheral components or systems such as a computer, an answering machine, a communications network, or a telephone line so as to increase functionality and sources of message information. Finally, in some aspects the device may be installed in or connected with appliances having control circuitry or processing capability for home automation.

### BRIEF DESCRIPTION OF THE DRAWINGS

FIG. 1 is a functional block diagram of an embodiment of a voice message recording and playback device.

FIG. 2 is a functional block diagram of an embodiment of a voice message recording and playback device connected to a computer.

FIG. 3 is a functional block diagram of an embodiment of a voice message recording and playback device connected to a telephone answering machine.

FIG. 4 is a functional block diagram of an embodiment of a voice message recording and playback device having a switch located therein.

FIG. 5 is a functional block diagram of an embodiment of a voice message recording and playback device connected to a communication network and a telephone line.

### DETAILED DESCRIPTION OF THE PREFERRED EMBODIMENT

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

Many, if not all, of the figures in the following description are functional diagrams containing functional modules that perform each corresponding function described. The term “module,” as used herein, means, but is not limited to, a software or hardware component, such as an FPGA or ASIC or other such component, which performs certain tasks. A module may also be configured to reside on an addressable storage medium and configured to execute on one or more processors. Thus, a module may include, by way of example, components, such as hardware components, software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

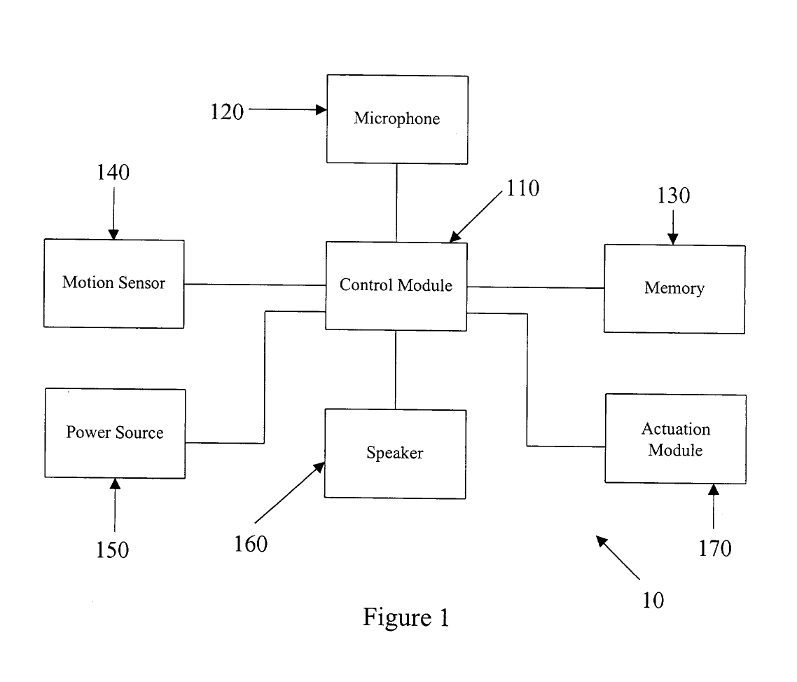

FIG. 1 is a functional block diagram of an embodiment of a voice message recording and playback device 10. The device 10 in this illustration has a control module 110 in communication with a microphone 120, a memory 130, a motion sensor 140, a power source 150, a speaker 160 and an actuation module 170. Many other components may be used, however, as discussed below, which may add additional features to the system disclosed. The device 10 illustrated in FIG. 1 can be contained in a single, portable housing or it may be contained in various different housings depending on the application. Many embodiments may utilize one or multiple speakers 160 or one or multiple microphones 120, all of which may be integral with the device 10, or its components, or may be remote from the device 10 and in communication with the device 10. This allows maximum flexibility depending on the application. The communication between the device 10 and the associated speakers 160 and microphones 120 may be by direct electrical connection, or by wireless connection such as via radio waves, infrared waves, a fiber optic element or any other communication system known in the art.

The control module 110 can be any of a number of components or combination of components capable of performing various tasks. The control module 110 may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The control module 110 receives information from the microphone 120 in either digital or analog form and stores it in the memory 130. If the information is in analog form, the control module 110 may convert it to digital form for further processing. The control module 110 may format the information received from the microphone 120 into a message format appropriate for storage in the memory 130. The memory 130 may consist of any storage medium including, but not limited to, RAM memory, DRAM memory, SDRAM memory, flash memory, ROM memory, EPROM memory, EEPROM memory, registers, hard disk, a removable disk, a CD-ROM, magnetic tape memory drive or system, or any other form of storage medium known in the art. The memory 130 can be in communication with the control module 110 such that the control module 110 can read information from, and write information to, the memory 130. In the alternative, the memory 130 may be integral to the control module 110. The control module 110 and the memory 130 may reside in an ASIC.

The motion sensor 140 is also in communication with the control module 110. The motion sensor 140 can be any sensor known in the art that is capable of developing a signal or charge upon the presence of motion in its proximity. This may include infrared sensors, radio wave sensors, light sensors, sound or sonar sensors, or any other such sensor known in the art. The motion sensor 140, upon detection of motion in its vicinity, sends a signal indicating this to the control module 110. The control module 110 then recalls the message stored in the memory 130 and sends it to the speaker 160 for playback. In some embodiments, the control module 110 may convert the message to an analog signal and amplify it so that the speaker 160 is able to play it at a sufficiently audible level. Each embodiment described here or later in this detailed description may also include a volume control (not pictured) to change the volume level of the playback.

As also illustrated in FIG. 1, the device 10 may utilize a power source 150 to operate. This power source 150 can be any source of electrical energy known in the art. Such sources may include but are not limited to; DC sources such as batteries or rectifiers, and AC sources such as outlet power common in buildings. Batteries may be disposable or rechargeable with the method of recharging being either from regular AC outlet power or other sources such as trickle charge sources. These trickle charge sources may include photovoltaic cells or other form of solar energy conversion process, or hydroelectric generation or wind driven generation as well as chemical energy generation sources Alternatively, the device 10 may be powered directly from such trickle charge sources.

The device 10 may be equipped with one or more actuation modules 170, or manual controllers. The actuation module 170 may perform any number of various functions. These functions may include, but are not limited to: prompting the control module 110 to record as a message the sounds being monitored by the microphone 120; prompting the control module 110 to playback a message stored in the memory 130; choosing between various messages in the memory 130 to playback, or interacting with other components as described later. The actuation module 170 may be a button, a switch, a keypad, a touch screen display or any combination of these or other types of controls. The actuation module 170 may also be a remote control unit in communication with the control module 110 via radio waves, infrared waves, an electrical conductor, a fiber optic element or any other communication system known in the art. In some embodiments, the control module 110 may operate under, or the actuation module 170 can put the control module 110 in, a voice activated mode such that certain sounds can activate the various functions above or any other function the device 10 is capable of performing. In some embodiments utilizing voice actuation, the device 10 can be trained to recognize certain sounds as control sounds in a training mode and those control sounds can then be assigned to the various functions the device 10 is capable of performing. These control sounds may be certain voice commands or may be more simple sounds such as a clap or some other sound. After the training is complete and the control sounds are stored, and when the device 10 is in voice activated mode, the occurrence of a control sound will cause the control module 110 to perform the corresponding function.

The device 10 can also include a timing sequence, relay or function. In embodiments utilizing the timing sequence, when a detection signal is generated by the motion sensor 140 and sent to the control module 110, the control module 110 will first determine if the timing sequence is active thereby precluding subsequent playback operations. When the timing sequence has completed an operating cycle, meaning that a sufficient preset time has passed, the control module 110 will cause a playback of the message or messages stored in the memory 130 upon subsequent detection signals from the motion sensor 140. Through this delay sequence, the device 110 will not play a message each time the motion sensor 140 senses motion. In such embodiments, a message that a user wants to be reminded of can be recorded into the memory 130 and then later, when the user passes by the motion sensor 140, the device 10 can play the message back thereby reminding the user of the information. But the delay circuit will prevent annoying repeated playback sequences as the user continues to be in the vicinity of the motion sensor 140, until the user leaves the vicinity for the pre-selected time. When the user returns after the timing sequence has passed, the message will be played back again, thereby reminding the user again. The timing sequence can be accomplished by a timing relay, a circuit, by a subroutine or by any hardware or software or combination thereof known in the art and it may be fixed or variable according to user needs. The timing sequence may occur in the control module 110, in the motion sensor 140 or its communication line with the control module 110, or it may occur anywhere else in the device 10 where it can serve its designed delay function.

In embodiments utilizing multiple motion sensors 140 and/or multiple speakers 160, the device 10 can be configured such that a timing sequence may be associated with each various location of components, which may include any combination of speakers 160, microphones 120, and motion sensors 140. In these configured embodiments, a particular motion sensor 140 may not trigger a message playback from the corresponding speaker 160 until an associated timing delay has expired for that location. Again, the control module 110 may track these timing sequences or they may be part of the motion sensor 140 such that the control module 110 only receives a motion detected signal from the motion sensor 140 when the delay has expired.

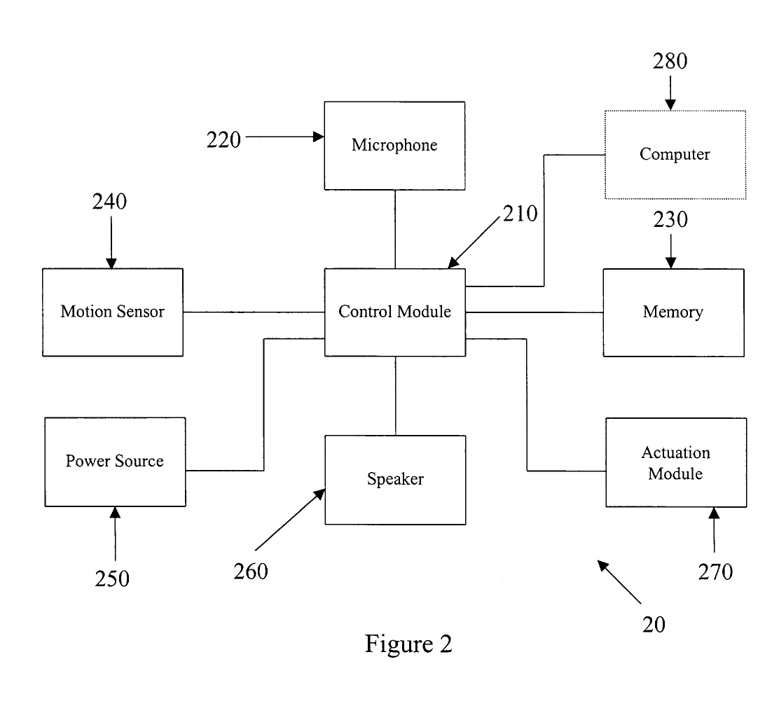

FIG. 2 is a functional block diagram of an embodiment of a voice message recording and playback device 20 connected to a computer 280. The embodiment illustrated in FIG. 2 has many components and features similar to those described above and illustrated in FIG. 1. The device 20 illustrated in FIG. 2 has a control module 210 that is in communication with a microphone 220, a memory 230, a motion sensor 240, a power source 250, a speaker 260 and an actuation module 270. Each of these components can be capable of fulfilling each of the functions that their corresponding components can perform as described above with respect to FIG. 1. But this embodiment also has a communications link to a computer 280 or other peripheral device. This link allows the control module 210 of this device 20 to interact with the computer's processor to access messages available to the computer 280. The device 20 illustrated in FIG. 2 can be contained in a single, portable housing or may be contained in various different housings depending on the application. In these embodiments, the device 20 may communicate with the computer 280 via the computer's USB port, serial port, parallel port, fire-wire port, or any other port used by the computer 280. In some embodiments, the device 20 may be installed in the computer 280 and can communicate with the computer 280 via one of the computer's expansion slots or any other connection.

The connection to the computer 280 can allow the device 20 to access any messages the computer 280 has access to. This can include, but is not limited to, messages on the computer's fixed or hard disk drive, floppy drive, CD drive, the computers RAM, or any applications the computer can utilize, such as email, instant messaging or other messaging application. Certain embodiments can have text-to-voice, or vice-versa, conversion applications available that convert text messages from the computer 280 to voice messages to be played back by the speaker 260 of the device 20 or to convert recorded messages into text messages to be stored in the memory 230, the computer 280 or elsewhere. The conversion application can be run on the computer 280, on the control module 210, in the memory 230, or any other component as determined by the specific application of the device 20. Such a device 20 can allow a user to retrieve an email message, or any other message, from the computer 280 and play it back through the speaker 260.

The device 20 may be equipped with one or more actuation modules 270, that are similar to the one described previously with respect to FIG. 1 and may serve and have all or some of the same functions and features. In addition to those functions and features listed above, the actuation module 270 may be able to execute certain commands on the computer 280 thereby activating certain applications and routines on the computer 280. These functions may include, but are not limited to, retrieving information from any of the computer's 280 memory storage locations, opening and operating an email application on the computer 280 to retrieve or record email messages, operate a text messaging application on the computer 280 to retrieve or record text messages, or operate any other application available on the computer 280. As described before, the actuation module 270 may be a button, a switch, a keypad, a touch screen display or any combination of these or other types of controls. The actuation module 270 may also be a remote control unit in communication with the control module 210 via radio waves, infrared waves, an electrical conductor, a fiber optic element or any other communication system known in the art. The controls of the computer 280 may be used as an actuation module 270 to activate any of the devices 20 functions.

In some embodiments, the control module 210 may operate under, or the actuation module 270 can put the control module 210 in, a voice activated mode such that certain sounds can activate the various functions above or any other function the device 20 is capable of performing. Similar to the voice activation system described above for FIG. 1, the device 20 can be trained, in some embodiments utilizing voice actuation, to recognize certain sounds as control sounds in a training mode and those control sounds can then be assigned to the various functions the device 20 is capable of performing. These control sounds may be certain voice commands or may be more simple sounds such as a clap or some other sound. After the training is complete and the control sounds are stored, and when the device 20 is in voice activated mode, the occurrence of a control sound will cause the control module 210 to perform the corresponding function. Hence, in certain embodiments the actuation module 270 may utilize voice activation to access email messages from the computer and then play those messages back using the speaker, while other embodiments may use voice activation to cause the computer to execute any of its functions.

The computer 280 may also be connected to, or in communication with, a communications network (not shown) to provide access to more messages for the device 20. The network may include any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI), wireless network, Asynchronous Transfer Mode (ATM) or any other connection means known in the art. Note that the computer 280 may be a desktop, server, portable, hand-held, set-top, or any other desired type of computer configuration. As used herein, the network can include any network variation such as the public Internet, a private network within the Internet, a secure network within the Internet, a private network, a public network, a value-added network, an intranet, and the like. Such a network can provide the device 20 access to email messages, instant text messages, FTP messages or any other sort of message. Through such network, the device 20 can playback to the user voice messages when activated by the actuation module 270. Alternatively, the device 20 can be capable of connecting directly to the network itself by an appropriate connection of the control module 210 or other component. This connection may be a telephone line interface, a coaxial cable interface, a LAN interface, an ethernet interface or any other connection interface known in the art. As with the device 10 described above with respect to FIG. 1, the device 20 in FIG. 2 can be equipped with an appropriate timing sequence to prevent unwanted repetitions of the playback sequence within a preset period of time.

The device 20 may utilize one or more microphones 220 to record messages and one or more speakers 260 to play the messages back, along with one or more motion sensors 240 each to detect motion in a certain area. The microphones 220, speakers 260, and motion sensors 240 can have all of the functionality of the microphone, speaker and motion sensor described above with respect to FIG. 1. The microphone(s) 220, speaker(s) 260 and motion sensor(s) 240 may be located near the control module 210 or they may be located remotely from the control module 210. In such remote embodiments, each remote microphone 220, speaker 260 or motion sensor 240 is in communication with the control module 210 via any of the communications systems mentioned above, such as radio waves, infrared waves, an electrical conductor, a fiber optic element or any other communication system known in the art. The device 20 may also utilize a power source 250 that is similar to any of the power sources mentioned previously in describing embodiments illustrated in FIG. 1. These may include AC or DC. These types of power may be supplied from any source known in the art such as rechargeable or consumable batteries, a building's supply power, trickle charge from solar, hydro or windmill charging devices, or any other source known in the art.

The device 20 can also include a timing sequence, relay or function as described previously with respect to FIG. 1. This timing function can be similar to that described previously with all of the functionality described therein. In embodiments utilizing the timing sequence, the device 20 will not play back a message each time the motion sensor 240 senses motion, rather it will wait until the timing sequence is complete. As described previously, in embodiments utilizing multiple motion sensors 240 and/or multiple speakers 260, the device 20 can be configured such that the timing sequence may be associated with various locations of components such as any combination of speakers 260, microphones 220, or motion sensors 240. In these configured embodiments, a particular motion sensor 240 may not trigger a message playback from the corresponding speaker 260 until an associated timing delay has expired for that location. Again, the control module 210 may track these timing sequences or they may be part of the motion sensor 240 modules such that the control module 210 only receives a motion detected signal from the motion sensor 240 when the delay has expired.

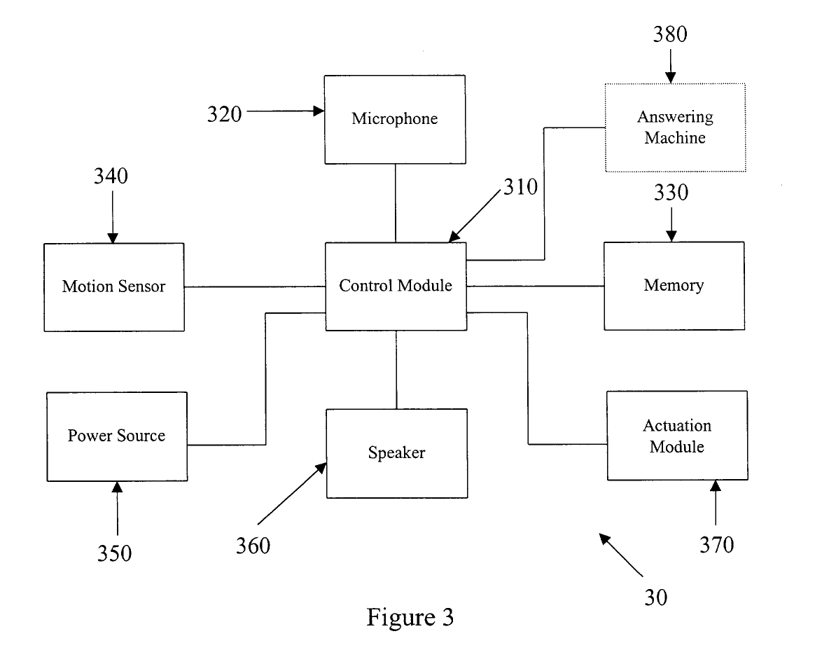

FIG. 3 is a functional block diagram of an embodiment of a voice message recording and playback device 30 connected to a telephone answering machine 380. In this embodiment, a control module 310 is in communication with a microphone 320, a memory 330, a motion sensor 340, a power source 350, a speaker 360, an actuation module 370 and an answering machine 380. The embodiment of the device 30 illustrated in FIG. 3 can have many or all of the features described above with respect to FIG. 1 and FIG. 2, and therefore those descriptions apply to these embodiments and their components as well as for those indicated above. Embodiments illustrated by FIG. 3, may similarly also utilize single or multiple microphones 320, single or multiple speakers 360 and single or multiple motion sensors 340, that may be located near to, or remote from, the control module 310. Also similarly, these embodiments may include a power source 350 that may be any of the sources described above. These may include AC or DC from any source known in the art such as rechargeable or consumable batteries, a building's supply power, trickle charge from solar, hydro or windmill charging devices, or any other source known in the art.

In addition to those features described above, the control module 310 can be in communication with an answering machine 380 so that messages on the answering machine 380 are available to the control module 310 for playback. In some embodiments, the control module 310 can be connected to an interface in the answering machine designed to accept outside control functions. This connection may be by any of the methods described above such as infrared, radio wave, electrical connection or any other connectivity method known in the art. Alternatively, the device 30 may be an integral part of the answering machine 380. In certain embodiments, messages saved on the answering machine 380 can be recalled and played back via the speaker 360 upon prompting by the motion sensor 340, which develops and sends a motion present signal to the control module 310. Also, the device 30 may be capable of executing all of the functions of the answering machine 380.

As with the embodiments described previously with respect to FIGS. 1 and 2, the device 30 illustrated in FIG. 3 can have one or more actuation modules 370 that are either attached to another component of the device 30 or are wholly separate from the device 30. In embodiments of the device 30 where the actuation module 370 is separate or remote from any other component, the actuation module 370 can be in communication with the device 30 via any of the connectivity methods described previously, such as radio wave, infrared wave, electrical wire, fiber optic wire or any others that are known in the art. The actuation module 370 may accept touch input such as by switches or buttons or a touch screen, or it may take audible commands. The device 30, similar to the embodiments described previously, may be voice activated recognizing certain sounds as control functions that prompt actions. The voice activation may be from the actuation module 370 or may be through the microphone 320, or it may through the answering machine 380. The controls of the answering machine 380 may be used to activate any of the functions of the device 30 as well.

In some embodiments, the device 30 illustrated in FIG. 3 will be able to connect to the internet. This connection may be as simple as initiating a call through the answering machine to a telephone line dial-up internet service provider (ISP), although any other internet or network connection may be used as well. Through a connection with the internet, the control module 310 is able to access network message services to find and download messages to play in the playback mode. The control module 310 can be designed to accept any type of message format available over the internet for versatility.

Again, the device 30 can also include a timing sequence, relay or function as described previously. In embodiments utilizing the timing sequence, the device 30 will not play back a message each time the motion sensor 340 senses motion, rather it will wait until the timing sequence is complete. In embodiments utilizing multiple motion sensors 340 and/or multiple speakers, the timing sequence may be associated with the various locations of components, such as any combination of speakers 360, microphones 320 or motion sensors 340, such that a particular motion sensor 340 will not trigger a message playback from the corresponding speaker 360 until an associated timing delay has expired.

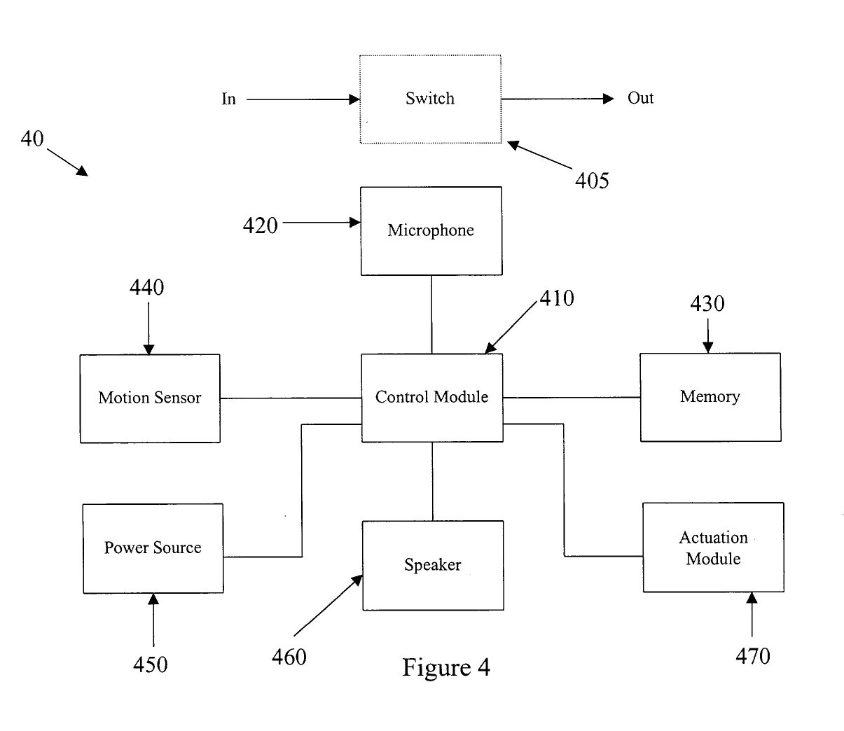

All of the embodiments described herein may have alternate embodiments wherein the components are either centrally located in one location or housing, and others where the components are separated from the other components in any combination to serve a desired application. Some embodiments may be designed to fit into wall outlets and fixtures. These may include standard electrical switch boxes, power outlet fixtures, light switch fixtures or any other fixture. FIG. 4 is a functional block diagram of an embodiment of a voice message recording and playback device 40 having a switch 405 located therein. In this embodiment, a control module 410 is in communication with a microphone 420, a memory 430, a motion sensor 440, a power source 450, a speaker 460, and an actuation module 470. The embodiment of the device 40 illustrated in FIG. 4 can have many or all of the features described previously with respect to FIGS. 1-3, and therefore those descriptions apply to these embodiments and their components as well as for those indicated above. Embodiments illustrated by FIG. 4, may similarly also utilize a single or multiple microphones 420, speakers 460, motion sensors 440, or actuation modules 470 that may be located near to, or remote from, the control module 410. These embodiments may also have the timing delay associated with the various motion sensors 440 used to avoid unwanted repetitious playback of a message, with all the variations and combinations described above. The actuation module 470 may accept touch input such as by switches or buttons or a touch screen, or it may take audible commands. The device 40, similar to the embodiments described previously, may be voice activated recognizing certain sounds as control functions that prompt actions. The voice activation may be from the actuation module 470 or may be through the microphone 420, or it may through any peripheral components the device 40 is connected to.

Also similar to previously described embodiments, embodiments illustrated by FIG. 4 may include a power source 450 that may be any of the sources described above. These may include AC or DC from any source known in the art such as rechargeable or consumable batteries, a building's supply power, trickle charge from solar, hydro or windmill charging devices, or any other source known in the art. In addition to all of the functionality described previously, embodiments illustrated by FIG. 4 may perform any of the functions of those devices but can also be located in a wall mounted fixture, or any other fixture. This allows a placement of the device 40 in convenient locations with an appearance that is integral with the building or structure in which it is mounted. Such embodiments may also be equipped with a functional switch 405 to maintain the functionality of the fixture in which the device 40 is located. This may include switches for electrical power such as for a light or for controlling outlet power to a wall outlet, but it can include any such functionality for which the fixture was designed to be used, which need not necessarily be a switch.

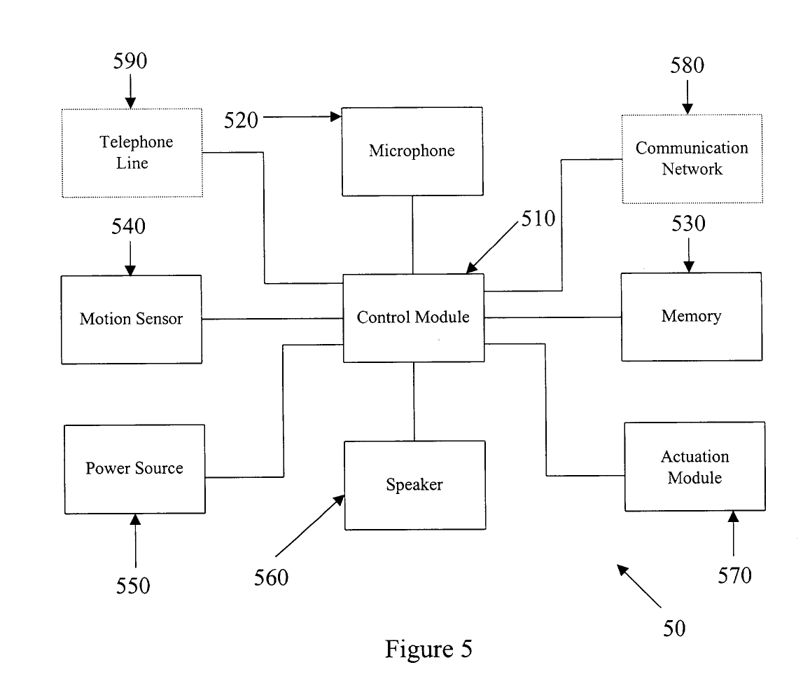

In other embodiments, a message recording and playback machine or system may directly connect to a system or network. FIG. 5 is a functional block diagram of an embodiment of a voice message recording and playback device 50 connected to a communication network 580 and a telephone line 590. In this embodiment, a control module 510 is in communication with a microphone 520, a memory 530, a motion sensor 540, a power source 550, a speaker 560 and an actuation module 570. The embodiment of the device 50 illustrated in FIG. 5 can have many or all of the features described previously with respect to FIGS. 1-4, and therefore those descriptions apply to these embodiments and their components as well as for those indicated above. Embodiments illustrated by FIG. 5, may similarly also utilize a single or multiple microphones 520, speakers 560, motion sensors 540, or actuation modules 570 that may be located near to, or remote from, the control module 510. These embodiments may also have the timing delay associated with the various motion sensors 540 used to avoid unwanted repetitious playback of a message, with all the variations and combinations described above. Also similarly, these embodiments may include a power source 550 that may be any of the sources described above. These may include AC or DC from any source known in the art such as rechargeable or consumable batteries, a building's supply power, trickle charge from solar, hydro or windmill charging devices, or any other source known in the art.

In addition to previously described functions, certain embodiments may be designed to interface with, or connect to, networks 580 or directly have access to telephone lines 590, or to both as illustrated in FIG. 5. These embodiments may be able to connect to home or office intercom or automation networks 580, but may also be able to connect with other networks 580 as well. These networks 580 may include any type of electronically connected group of computers including, for instance, the following networks: Internet, Intranet, Local Area Networks (LAN) or Wide Area Networks (WAN). In addition, the method of connection to the network 580 may be, for example, remote modem, Ethernet (IEEE 802.3), Token Ring (IEEE 802.5), Fiber Distributed Datalink Interface (FDDI), wireless network, Asynchronous Transfer Mode (ATM), radio waves, infrared waves, an electrical conductor, a fiber optic element or any other communication system known in the art. Other embodiments may be connected to a telephone line 590 to access outside communication systems, such as dial-up internet service, or any other telephone based service.

In such embodiments, the actuation module 570 may accept touch input such as by switches or buttons or a touch screen, or it may take audible commands. The device 50, similar to the embodiments described previously with respect to FIGS. 1-4, may be voice activated recognizing certain sounds as control functions that prompt actions. The voice activation may be from the actuation module 570 or may be through the microphone 520, or it may through the network 580 or telephone line 590 to which the device 50 is connected.

In some embodiments, the device 50 is connected to a home intercom system with multiple speakers 560 and multiple microphones 520 such that a user entering a specific room in a house would trigger a motion detection signal in the motion sensor 540 for that room, thereby sending a motion detected signal to the control module 510, which may be located anywhere in the intercom system 580 or may just be in communication with the communication system 580 via any of the connection methods previously described. The control module 510 can then check for a timing sequence, if that function is not performed by another module such as the motion sensor 540. If there is no currently active timing sequence, the control module 510 may retrieve the message stored in the memory 530, or it may select one message to playback if multiple messages are stored in the memory 530, and play it at the appropriate speaker 560.

In such a system, and in any embodiment described previously, the device 50 may be equipped with many speakers 560, microphones 520, motion sensors 540 or actuation modules 570. Such remote componentry would allow for remote message generation at any microphone 520 location, remote playback at any speaker 560, remote motion detection at any motion sensor 540 and remote control of the system from any actuation module 570. Again, the actuation modules 570 in these embodiments may include a button, a switch, a keypad, a touch screen display or any combination of these or other types of controls. They may also include a remote control unit in communication with the control module 510 via radio waves, infrared waves, an electrical conductor, a fiber optic element or any other point to point communication system known in the art.

In some embodiments, the actuation module 570 can put the control module 510 in a voice activated mode such that certain sounds can activate the various functions above or any other function the device 50 is capable of performing. In some embodiments utilizing voice actuation, the device 50 can be trained to recognize some sounds as control sounds in a training mode and those control sounds can then be assigned to the various functions the device 50 is capable of performing. These control sounds may be certain voice commands or may be more simple sounds such as a clap or some other sound. After the training is complete and the control sounds are stored, and when the device 510 is in normal operation, the occurrence of a control sound will cause the control module 510 to perform the corresponding function.

Several embodiments can be adapted for use by or in automated home appliances as well. Automated home appliances have been developed that utilize logic circuitry to execute tasks and are capable of connection to a home networking system to send and receive information about the operation of the appliance. For instance, an automated refrigerator may have a processor, sensors and memory allowing it to store information about the performance of the refrigerator over a period of time. The refrigerator may be connected to a network via electrical connection, such as telephone line, network line or powerline communication, via wireless connection such as radio wave or infrared wave communication, or via any other communication link known in the art. The refrigerator can then pass information stored in its memory or available to its processor over the network for use by other system components like a computer, another appliance, or via the internet to other networks and workstations. The device 50 could then interface with this refrigerator either via a connection or as an integral component to perform its functions. The device 50 could be used to store messages at the refrigerator or elsewhere in the network, as well as detecting motion in the vicinity of the refrigerator and playing selected messages via the speaker 560 at the refrigerator. The device 50 could also utilize the refrigerator's connection to the network, or its own network connection 580 or telephone line connection 590, to access information from the home network system or other network systems via the internet or other similar public or private network for use by the device 50 in any of the functions described above. Although this example illustrates use by a refrigerator, such embodiments could be used by any device or appliance that is equipped with such a logic system or processing system. Such appliances and devices may include, but are not limited to, refrigerators, dishwashers, ovens, stoves, freezers, washing machines, dryers, audio equipment (including receivers, amplfiers, pre-amplifiers, equalizers, CD players, digital audio media players, MP3 players, etc.), video equipment (including VCRs, televisions, digital video recording devices, DVD players, etc.), speakers, heating and cooling systems, lamps, irons, toaster ovens, microwave ovens, or any other home appliance or electrical device.

As mentioned previously, for each embodiment described herein, it may be likely that the components can all be contained in a single container, which may be compact or may be large. Alternatively, the components for each embodiment may be separated in any manner desired to enhance performance, flexibility in function, or to improve functionality overall. For instance, all of the components may be contained in a small portable hand-held unit capable of being carried around. Alternatively, the components may be situated in separated locations to facilitate sound reproduction of the speaker, or enhancement of the motion sensor, or for any other desired performance improvement. It is also possible that each of the components are designed to fit with existing structures, components or fixtures so that the device can be conspicuous. Each of these variations can be used together or in combination with one another and comport with the intent of the device.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A digital message recording and playback device, comprising:
a microphone;
a memory;
a motion sensor;
a speaker; and
a controller in communication with the memory, motion sensor, microphone and speaker that accepts one or more message signals from the microphone and stores them in the memory, wherein upon receiving a motion signal from the motion sensor, retrieves the one or more message signals from the memory and transfers them to the speaker for playback, and wherein the controller utilizes a timing control that prevents motion signals from triggering a subsequent playback until a preset period of time has elapsed.

2. The digital message recording and playback device of claim 1, further comprising an actuation module for manually actuating a playback of the message signals.

3. The digital message recording device of claim 1, wherein the device is contained in a portable housing.

4. The digital message recording and playback device of claim 3, further comprising an actuation module for manually actuating a playback of the message signals.

5. The digital message recording device of claim 4, wherein said actuation module may be a remote control.

6. The digital message recording and playback device of claim 4, wherein the actuation module for manually actuating a playback comprises a voice actuation module.

7. The digital message recording and playback device of claim 1, wherein the device is mounted into a switch housing and is adapted to use AC power.

8. The digital message recording and playback device of claim 1, wherein the device is in communication with a computer

9. The digital message recording and playback device of claim 8, wherein the device is adapted for voice actuated playback.

10. The digital message recording and playback device of claim 8, wherein the device is adapted to retrieve an email message from the computer and playback the email message as a voice message.

11. The digital message recording and playback device of claim 1, wherein the device is in communication with a telephone answering machine and is adapted for manual actuation.

12. The digital message recording and playback device of claim 11, wherein the device is also voice actuated.

13. The digital message recording and playback device of claim 11, wherein the device is further adapted to access the internet and receive messages thereby.

14. The digital message recording and playback device of claim 7, further comprising a light switch for actuating a light.

15. The digital message recording and playback device of claim 1, wherein the device is in communication with a communications network and is also adapted to utilize a remote microphone and a remote speaker.

16. The digital message recording and playback device of claim 15, wherein the device is adapted to accept voice and text messages to be played back through the speakers.

17. The digital message recording and playback device of claim 15, wherein the device is connected to a telephone line and is adapted to make and receive telephone calls and is further adapted to store messages from the telephone line in the memory.

18. The digital message recording and playback device of claim 15, further adapted to utilize a trickle charge power source.

19. The digital message recording and playback device of claim 6, wherein the device is adapted for use in an automated appliance.

20. The digital message recording and playback device of claim 6, wherein the device is adapted for use in an automated device.
